(19) United States
(12) Patent Application Publication
(10) Pub. No.: US 2005/0279096 A1
(43) Pub. Date: Dec. 22, 2005

(54) Waste heat generator

(76) Inventors: Dwight W. Hoover, Broadway, VA (US); Joan H. Shifflett Hoover, Broadway, VA (US)

Correspondence Address: Joan H. Shifflett, 247 Turner Ave, Broadway, VA, 22815, US

(21) Appl. No.: 11/146,270

(22) Filed: Jun. 6, 2005

Related U.S. Application Data
(60) Provisional application No. 60/581,460, filed on Jun. 22, 2004.

(51) Int. Cl. F02G 3/00; B60K 16/00; B60L 8/00; F03G 6/00

(52) U.S. Cl. 60/641.8; 60/620

(57) ABSTRACT

A closed system that operates using a refrigerant and waste heat. The waste heat can be obtained from a turbine; a nuclear power house or any heat source up to two hundred degrees Fahrenheit. The refrigerant is introduced to said system and is routed to the hot water shell (14). Refrigerant is then routed directly to the pressure dome (30). Vapor is discharged from the pressure dome (30) using the discharge pipe (34). Vapor drives any piston type or turbine. The vapor is then transported to the condenser tank (46) that contains cooling tubes surrounded by water. This process brings the vapor back to a refrigerant liquid. Refrigerant liquid is then routed to the liquid return pipe (52) and into a twenty-gallon liquid reservoir (56). Refrigerant pump (68) pumps the liquid back into the refrigerant reservoir (10) where the process is again initiated.

### CROSS-REFERENCE TO RELATED APPLICATIONS

This application claims the benefit of PPA Ser. No. 60/581,460, filed 2004 Jun. 22 by the present inventors.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention generally relates to a low cost energy generating system that utilizes waste heat and refrigerants.

### BACKGROUND OF INVENTION—PRIOR ART

Because of the rapidly rising costs of energy, the incentives to conserve energy are increasing, both for industrial users and domestic users. Consequently, there is currently considerable interest in not only eliminating energy waste by making equipment more efficient, but also by recovering energy such as waste heat, which, according to conventional practice, is usually injected into the atmosphere without recovery. However, some sources of waste heat have characteristics that result in excessively high costs to generate useful thermal or power output, which makes it uneconomical for industry and equally uneconomical for individuals and smaller entities. There is also a need to develop innovative energy concepts that does not require the use of our natural resources such as oil or natural gas or wood.

My invention can take the waste heat (or any heat source) from a variety of sources, to include but not limited to a solar collector; a generator; a vehicle engine; a power plant; various types of fuel cells and gas-fired or electrical heating elements and use the waste heat from that source up to 200 degrees Fahrenheit to produce additional energy. My invention does not require the use of natural resources but rather operates with the use of refrigerants, commercially produced products that are replenish able.

### BACKGROUND OF INVENTION—OGJECTS AND ADVANTAGES

Accordingly, besides the objects and advantages of the Waste Heat Generator described above, several objects and advantages of the present invention are:
(a) to generate additional energy off of the waste heat (or any heat source) up to two hundred degrees Fahrenheit.
(b) To provide an economical energy source to remote locations
(c) To decrease the need for natural gas and oil by using refrigerants

### SUMMARY

It is a principal object of the present invention to generate additional energy off of the waste heat or any heat source up to two hundred degrees Fahrenheit with the use of refrigerants.

### DRAWING FIGURES

FIGS. 1 and 2 are a perspective view of my invention.

FIG. 3 is an inside view of the portion indicated by the section lines 10; 14; 30 in FIG. 1.

FIG. 4 is a view in detail of the portion indicated by the section lines 10; 14; 18; 22; 62; 64; 68 and 72 in FIG. 1.

FIG. 5 is a view in detail of the portion indicated by the section lines 62; 64; 68 in FIG. 1.

### REFERENCE NUMERALS IN DRAWINGS

10 refrigerant reservoir
14 hot water shell
14A hot water tubes
18 hot water shell cut off valves
22 glass viewing window
26 pressure gauge
30 pressure dome
34 discharge pipe
38 turbine and turbine housing
42 condensor pipe
46 condenser tank
48 condenser cutoff valve
52 liquid return pipe
56 liquid reservoir for gravity feed
60 glass viewing window for liquid reservoir
64 cutoff valve
68 refrigerant pump
72 drain pipe

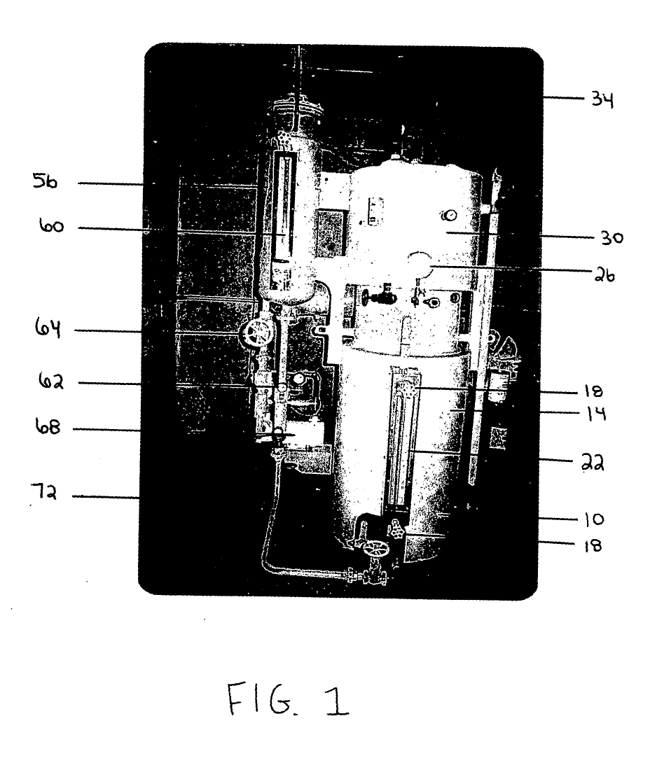

### DESCRIPTION—FIGS. 1; 2; 3; 4; 5

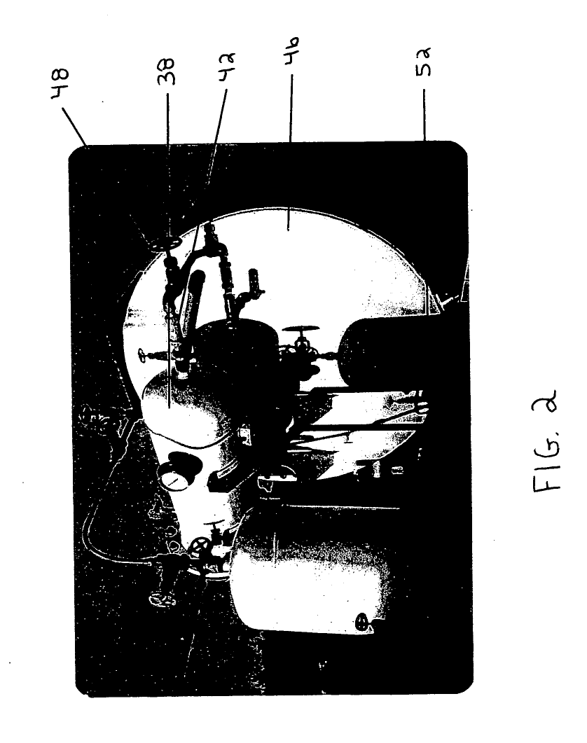

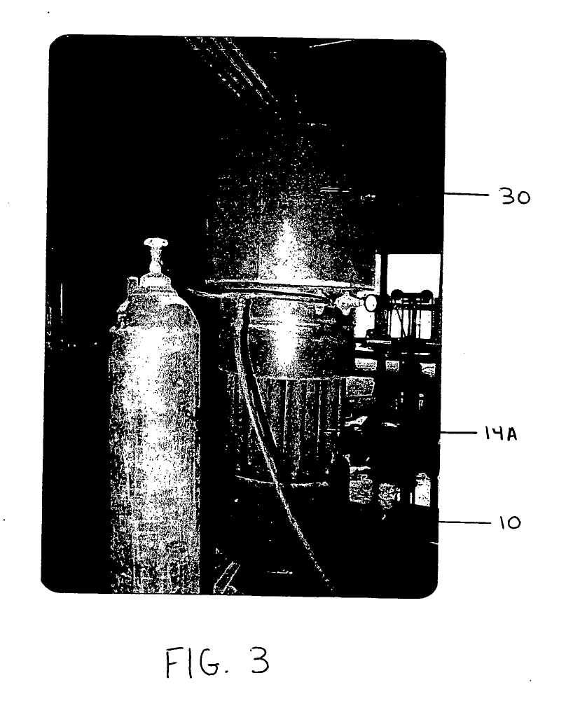

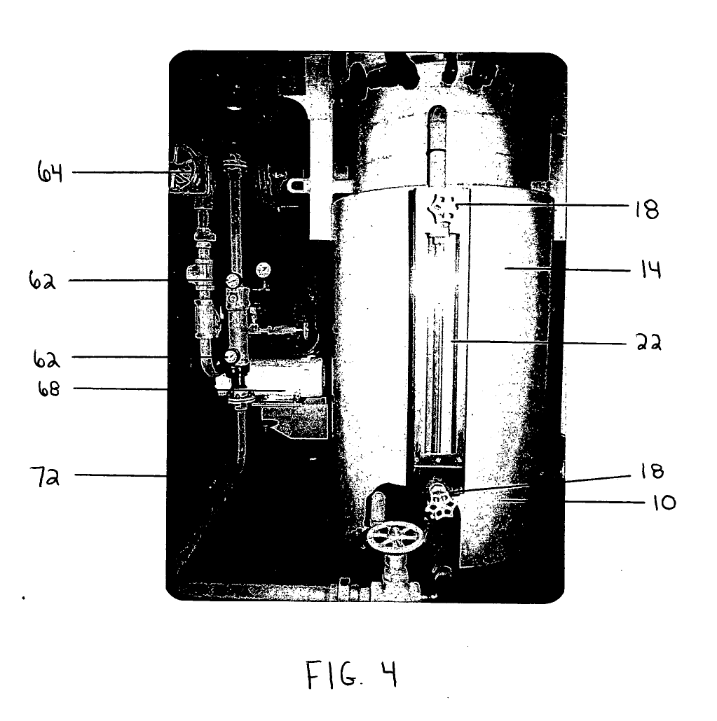

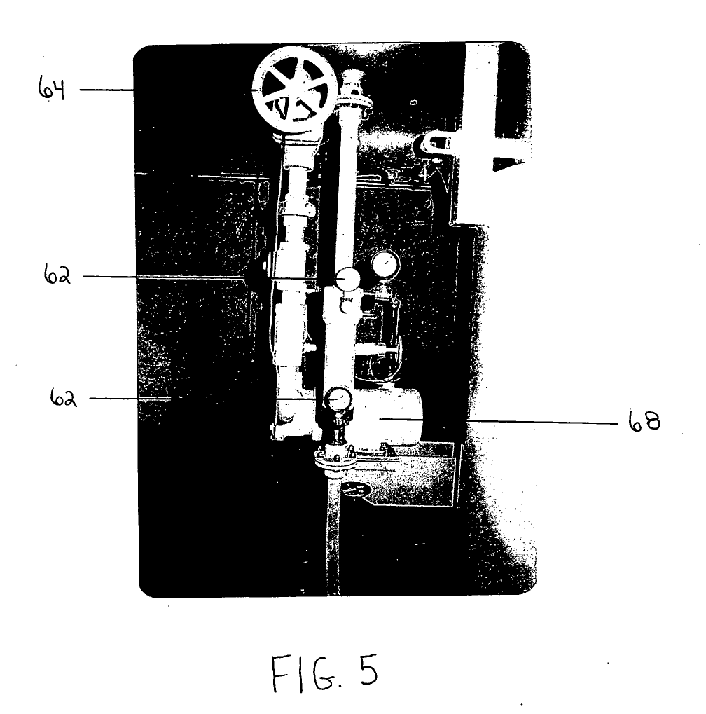

A preferred embodiment of the present invention of the waste heat generator is illustrated in FIG. 1 and FIG. 2. The said invention is a closed system that operates using a refrigerant and waste heat. The waste heat can be obtained from a turbine; a nuclear power house or any heat source up to two hundred degrees Fahrenheit. My invention was tested using the refrigerant propane, however, any number of environmentally compatible refrigerants would work.

The refrigerant is introduced to said system by the refrigerant reservoir 10 and is routed into the hot water shell 14 where the refrigerant is surrounded by hot water tubes 14A and begins the process of going from liquid to vapor. The glass viewing window 22 is used to monitor refrigerant level and the hot water shell cutoff valves 18 are included to restrict or cutoff the flow.

The refrigerant is then routed directly to the pressure dome 30 where, under pressure, the refrigerant vaporizes according to the temperature. My invention was tested at 900 p.s.i. The pressure gauge 26 records the amount of pressure in the pressure dome 30.

The vapor is discharged from the pressure dome 30 using the discharge pipe 34. The discharge pipe 34 transports the vapor to the turbine and turbine housing 38. The vapor drives any piston type or turbine. My invention shows the turbine enclosed inside the turbine housing 38, however, an alternative embodiment could be located a distance away from the structure.

The vapor is then transported by the condenser pipe 42 to a three thousand gallon condenser tank 46 that contains cooling tubes surrounded by water. This process brings the vapor back to a refrigerant liquid. My invention uses water as a coolant but fans can also be used for cooling as can cooling by routing the vapor underground. The condenser cutoff valve 48 is used to control the condenser process.

The refrigerant liquid is then routed to the liquid return pipe 52 and into a twenty-gallon liquid reservoir 56. Although my invention shows the use of the liquid reservoir 56, I would recommend this as an alternative method. The liquid reservoir 56 is gravity feed method and can be used when no electricity is available. A glass-viewing window for the liquid reservoir 60 is used to monitor the liquid level. Pressure gauges for the return pipe 62 are used to monitor the pressure of the refrigerant liquid and cutoff valves 64 are used to control the process.

The preferred embodiment is a refrigerant pump 68 that pumps the liquid back into the refrigerant reservoir 10 where the process is again initiated.

The drainpipe 72 is used to drain liquid from the system.

1. Said invention can take the waste heat (or any heat source) from a variety of sources, to include but no limited to a solar collector; a generator; a vehicle engine; a power plant; various types of fuel cells and gas-fired or electrical heating elements and use the waste heat from that source, up to 200 degrees Fahrenheit to produce additional energy.
